(19) United States
(12) Patent Application Publication
(10) Pub. No.: US 2021/0138683 A1
(43) Pub. Date: May 13, 2021

(54) Wood Chipping Knife for use with Clamping Assembly

(71) Applicant: Lindsay Forest Products, Inc., Vancouver, WA (US)

(72) Inventor: Bror Eriksson, Njutanger (SE)

(73) Assignee: Lindsay Forest Products, Inc., Vancouver, WA (US)

(21) Appl. No.: 17/069,387

(22) Filed: Oct. 13, 2020

Related U.S. Application Data
(60) Provisional application No. 62/933,639, filed on Nov. 11, 2019.

(51) Int. Cl. B27G 13/10; B27G 13/04

(52) U.S. Cl. CPC B27G 13/10; B27L 11/005; B27G 13/04

(57) ABSTRACT

A polyhedral knife that in side profile resembles a gull wing is configured for being securely retained in a clamping assembly defined by a clamp and a holder, wherein the knife is retained between the clamp and the holder. The knife has a central portion between opposite wing portions. The knife is rectangular in shape and has a central, upwardly extending semi-circular upper ridge that extends across the knife on the upper surface and the upper ridge defines a locator that is retained in a cooperatively shaped groove in the clamp. The lower surface of the knife is defined by a central locator ridge and concave surfaces on opposite sides of the locator. The clamp and the holder have cooperatively shaped, angled and radiused surfaces to mate with facing surfaces of the knife.

### TECHNICAL FIELD

The present invention relates to wood working equipment used in the forest products industry, and more particularly a chipping knife configured for use with a clamping assembly, wherein the clamping assembly comprises a holder and a clamp for securely retaining the chipping knife in the clamping assembly.

### BACKGROUND

Logs that are cut for use in the production of finished wood products go through many different processing steps subsequent to the harvesting of trees, the number and type of processing steps depending upon factors such as the finished product that is ultimately being produced. In many instances logs may be debarked prior to processing the logs through a chipping machine that transforms the logs into chips. There are many different types of chipper machines.

Logs may be processed by machines that remove portions of the logs to form the rough finished product, and of course there are wood chips generated during the processing.

Most chipping machines utilize a plurality of knives that are mounted to a base that moves the knives relative to the wood that is being chipped. Typically, the base is adapted for rotation—such as a rotating disk or drum. As the disk or drum, which holds plural knives, rotates, wood is moved into the disk and the knives, and the knives do their job: namely, chipping the wood. Of course, the knives are chosen and adjusted according to the nature of the chips that are desired. Thus, the depth and shape of the chips can be determined by the type and adjustment of the knives.

Like almost all knives, the cutting blades that are used in the process of chipping wood become worn, dull and often damage over time and repeated contact with the wood, which is often tough on knives. As the knives dull over time, the efficiency of the chipping is reduced and the shape of the chips or the cut surface of the wood may be different from what is desired. As such, the knives need to be changed out periodically. There are a variety of strategies for maintaining the knives in good working condition. For instance, the knife blades may be removed from the clamping assembly, sharpened, and replaced. This is a time-consuming operation since there are multiple knives that require removal, sharpening, and replacement and while that is happening the machine cannot be used for its intended purpose. Sharpening the cutting edges of the knives also removes material from the knives, which can result in a change of shape and resulting changes in the cutting geometry. Removal of material from the knives can also result in the location of the cutting edge being changed from its intended position. This can adversely affect not only the cut wood, but the operation of the chipping machine. As such, adjustments to other components of the chipping machines, such as anvils and guide plates.

Given the mechanical shock that is exerted on knives, combined with the varying density of the wood that is being cut (e.g., heart wood, knots, etc.), it is not surprising that it is very important the knives are securely fastened to the knife holders. But this can be a difficult task and some undesirable twisting and displacement of the knives relative to the holders is inevitable as a result of torque applied during cutting.

Moreover, chipping machines often operate in extreme environments and they are subjected to significant forces during operation. Among other forces acting on chipping machines, there are substantial loads and mechanical shock applied against the knives and the associated components such as the holders and clamps during operations. Chipping machines are manufactured sturdily to counteract some of the forces they encounter during use but given the extreme environment in which the machines often operate, the machines require frequent maintenance. This is especially true of the knives, which as noted tend to be damaged and dulled with some frequency. From a maintenance and economic standpoint, it is preferable to utilize knife assemblies that provide the maximum lifetime with minimal damage from normal wear and tear and there is, therefore, a need therefore for improved knife assemblies for use in chipping machines.

### SUMMARY OF THE INVENTION

The invention defines a knife that is adapted for use with a clamping assembly that facilitates precise positioning and securement of the knife relative to the clamping assembly every time that the knife is serviced and/or replaced, and which maintains precise positioning of the knife during use.

In a preferred and illustrated embodiment the knife comprises

a rectangular main body having a center line, and upper and lower surfaces;

an upwardly extending locator on the upper surface;

wherein in side profile the main body defines a gull wing shape in which the upper surface slopes downwardly on opposite sides of the locator and the lower surface defines a concave surface on opposite sides of the center line and wherein the upper surface and lower surface meet on respective opposite sides of the main body to define first and second knife cutting edges.

In a preferred and illustrated embodiment the knife further comprises an upper surface having

a first planar section, a second planar section adjacent to and outwardly of the first planar section, and a third planar section adjacent to and outwardly of the second planar section.

Wherein the lower surface is concave.

, And wherein the second planar section of the upper surface slopes downwardly relative to the first planar section and the third planar section slopes downwardly relative to the second planar section.

### BRIEF DESCRIPTION OF THE DRAWINGS

The invention will be better understood, and its numerous objects and advantages will be apparent by reference to the following detailed description of the invention when taken in conjunction with the following drawings.

FIG. 1 is a side elevation and slightly perspective view of the assembly comprising a knife according to the present invention, the holder and the clamp.

FIG. 2 is a top plan view of a preferred and illustrated knife according to the present invention, wherein the knife is shown in isolation.

FIG. 3 is an upper perspective view of an assembly comprising the clamp, holder and the knife according to the invention, shown in an assembled configuration and similar to the assembly shown in FIG. 1.

FIG. 4A is a side elevation view of the assembly shown in FIG. 3, showing the assembly with the components loosely interconnected and not torqued together.

FIG. 4B is a side elevation view of the assembly shown in FIG. 3, showing the assembly with the components torqued together as they would be during use.

FIG. 5 is a side elevation view of the assembly shown in FIG. 3 and in which the components are shown in an exploded view.

FIG. 6 is a side elevation view of a first and preferred embodiment of a knife according to the present invention, illustrating relative dimensions and angular relationships.

FIG. 7 is a side elevation view of an alternate embodiment of a knife according to the present invention, illustrating relative dimensions and angular relationships.

. FIG. 8 is a side elevation view of yet another alternate embodiment of a knife according to the present invention.

### DETAILED DESCRIPTION OF ILLUSTRATED EMBODIMENTS

The invention will now be described in detail with reference to the drawings. It will be understood that relative directional terms are used at times to describe components of the invention and relative positions of the parts. As a naming convention, the ground plane is considered to be a horizontal surface and relative directional terms correspond to this convention, and in the drawings, the ground plane is considered to be a horizontal line at the base of each drawing figure. With this convention, “upper” refers to the direction above and away from the ground plane; “lower” is generally in the opposite direction, “inward” is the direction from the exterior toward the interior of a component of the invention, “vertical” is the direction normal to the horizontal ground plane, and so on.

With reference now to FIG. 1, the knife 10 according to the present invention is shown assembled with the clamping assembly, which is defined by the holder 100, and the clamp 200. A bolt 300 extends through aligned bores in the clamp and the holder to retain the knife in an operative position, as shown in FIG. 1, between the clamp and the holder (the bolt does not extend through the knife 10). The invention described herein is the knife 10, which is designed to provide efficient chipping operations, long life, and ease of use and interchangeability. The knife is designed with certain surfaces and structures that are arranged in spatial and angular orientations and that contribute to the effective performance of the knife. Those features are detailed below. In use the knife is operatively retained between the holder and the clamp, which have cooperatively configured surfaces to retain the knife securely in the desired orientation relative to the clamp and holder. Each of the three components, the knife 10, holder 100 and clamp 200 will be described separately prior to describing the assembly of the three components.

### Knife 10

Knife 10 is a polyhedral member that in side profile substantially resembles a gull wing shape (see, e.g., FIGS. 1, 4 and 5) that is defined by a central portion 12 with opposite wing portions 14 and 16 extending from the central portion. As may be seen in in the top plan view of FIG. 2, the knife 10 is rectangular in shape with a central, upwardly extending semi-circular upper ridge 18 that extends across the width of the knife on the upper surface 20 of the knife; the gull wing portions 14 and 16 extend from the central portion 12 and the outer edge of each gull wing portion defines a knife edge 22. The first knife edge is labelled 22a, the second is identified with reference number 22b. A semi-circular, laterally extending ridge 24 extends across the lower surface 26 of the knife, opposite the upper ridge 18. The rectangle that is defined by knife 10 may have sides that are of unequal length, as shown, or may have sides that are equal length (i.e., a square).

With reference to FIG. 6, the knife 10 is shown in an elevation view so that the various surfaces may be seen, and their relative angular relationships may be explained. Generally, knife 10 is bilaterally symmetrical about the lateral axis that extends along the knife as shown with axis A in FIG. 2, which is the center line along the main body of the knife. Returning to FIG. 6, the preferred semi-circular curvature of upper ridge 18 is shown. Immediately outward and on opposite sides of the upper ridge 18 on upper surface 20 are two flattened, planar surface portions 28a and 28b, which preferably are parallel to a horizontal ground plane in the illustration. Immediately outward of the flattened portions 28a and 28b are similar first sloping planar portions 30a and 30b that slope downwardly relative to the flattened portions 28a and 28b. The preferred angular slope of the first sloping portions 30a and 30b is within the range of 150 to 170 degrees (angle A) in FIG. 6. Immediately outward of the first sloping portions 30a and 30b are second sloping, planar portions 32a and 32b, each of which terminates at the respective outermost edges of the main body, which define knife cutting edges 22a and 22b as noted below. The preferred angular slope of the second sloping portions 32a and 32b is within the range of about 100 to 120 degrees (angle B). The junction of the first and second sloping portions defines a laterally extending line that is identified in the drawings with reference number 36. It will be appreciated that the dimensions, relative dimensions, angular slopes and radial curvatures illustrated in FIG. 6 are preferred and exemplary but are not limiting.

The lower surface 26 of knife 10 is defined by opposed concave arcuate surfaces 34a and 34b that are smoothly arcuate and extend on opposite sides of the lower ridge 24 to the knife edges 22a and 22b, respectively. The outermost edges of the respective arcuate surfaces 34a and 34b meet the outermost edges of the upper surface to define the respective cutting edges 22a and 22b.

As with the angular slopes shown in FIG. 6, the radial curvature of arcuate surfaces 34a and 34b shown in FIG. 6 are exemplary but not limiting.

### Holder 100

The relationship between knife 10, holder 100 and clamp 200 will now be explained. Generally speaking, in the assembled combination of the knife, holder and clamp, the knife is securely captured between the holder and the clamp and the holder and the clamp define complementary surfaces that mate with surfaces on the knife. Holder 100 is the lowermost component of the combination and, with reference to FIGS. 1 and 5, and beginning at the left side of the holder, defines a convex arcuate surface 102 that begins at edge 104 and slopes downwardly therefrom. The radius of curvature of convex arcuate surface 102 of holder 100 is the same as the radius of curvature of concave arcuate surfaces 34a and 34b of knife 10. As such, when the knife 10 is fitted onto the holder 100 as shown in the figures with the lower ridge 24 of knife 10 immediately adjacent edge 104 of holder 100, the surface 34a (or 34b, as the case may be—the knife 10 is reversible) closely aligns with the mating surface 102. The convex arcuate surface 102 transitions to a flattened surface portion 106 across the body 108 of holder 100, and flattened surface portion 106 then turns upwardly at a 90-degree corner 110 that defines a shoulder 112. Although it is not shown in the drawings, a threaded bore is formed centrally in holder 100 to receive the bolt 300. Alternately, a through bore is formed centrally in holder 100 and the bolt 300 may be threaded into a filler block, other segment, or a nut beneath the holder to secure the assembly together.

### Clamp 200

Clamp 200 is similarly cooperatively configured to secure knife 10 between the clamp and the holder. A laterally extending semi-circular groove 202 extends across the lower surface 204 of clamp 200. Groove 202 has a radius of curvature that is the same as the radius of curvature of upper ridge 18 of knife 10 so that when the clamp is assembled with the knife, the upper ridge 18 is received in and mates closely with the groove 202. Groove 202 is positioned on clamp 200 such that the groove is separated from the adjacent outer edge 206 of the clamp by a distance such that when the knife and clamp are assembled, the outer edge 206 of the clamp is closely aligned with laterally extending line 36 that is defined by the junctions of the first sloping portions 30a and 30b and the second sloping portions 32a and 32b. This positional relationship is best seen in FIG. 1.

In FIG. 4A the combination of the knife 10, holder 100, clamp 200 and bolt 300 are shown loosely assembled—that is, the bolt 300 is not torqued to compress the assembly together. As may be seen in this figure, when the assembly is in an untightened condition there is point of contact 252 between the knife 10 and clamp 200 on between the surfaces 30a of the knife, and the facing surface 210a of the clamp. There is a small gap 250 formed between the other surfaces of the knife 10 and the clamp 200. With reference to FIGS. 4A and 5, the lower surface 210a of clamp 200 is angled at a slightly different slope relative to the mating surface of knife 10, namely, surface 28a but has a slightly different angle relative to the angle of surface 28a. As a result, when the knife and clamp are assembled as shown in FIG. 4A there is contact between surface 30a (of knife 12) and surface 210a of clamp 200, the small gap 250 is defined between remaining facing surface of the knife and clamp. In a preferred embodiment, the angular difference between surfaces 28a and 210a (when in an unassembled condition) is about 1 to 1.7 degrees. Because the slope of surface 28a is slightly different from the slope of surface 210a, the gap 250 is defined between the knife and the clamp between these two surfaces—the width of the gap increases moving in the point of contact 252 and moving in the direction toward semi-circular upper ridge 18. The gap is illustrated best in the view of FIG. 4A, which again shows the assembly in an un-torqued state. The junction of the surfaces 208a and 208b with the adjacent surfaces 210a and 210b, respectively, define laterally extending junction lines 212. When the knife 10 is assembled with the clamp 200 the junction lines 36 of the knife align with the mating junction lines 212.

Referring now to FIG. 4B, the knife 10, holder 100, clamp 200 and bolt 300 are illustrated in a torqued condition—that is, bolt 300 has been tightened to a proper torque and the combination is ready for operational use. In this torqued condition there are three points of contact established between the upper surface 20 of knife 10 and the lower surface 204 of clamp 200. Specifically, there is the first point of contact 252 (already described), a second point of contact 254 at the mating surfaces 30b of knife 10 and 210b of clamp 200, and a third point of contact 256 between the concave lower surface 34b of knife 10 and the facing convex arcuate surface 102 of holder 100. In this torqued condition the is no contact between the knife 10 and clamp 200 at the facing surfaces 28a and 208a, and 28b and 208b, respectively.

The clamp as just described leaves the knife edge 22a exposed for cutting. The opposite knife edge 22b is retained in the interior of the clamp, knife, holder assembly and as shown in, for instance, FIG. 1, there is no need for an angular surface on the clamp to mate with the surface 32b of the knife. As may be seen in FIG. 3, the upper surface 214 of clamp 200 includes a countersunk bore 206 through which bolt 300 extends. The lower surface 204 of claim 200 is complementary to the upper surface 20 knife 10 as described above, and also to the flattened surface 106 of holder 100. More specifically, the lower surface 204 includes a flattened portion 220 that is aligned with the facing flattened surface 106 of holder 100, and a reverse shoulder 222 that mates with the shoulder 112 of the holder.

When the knife 10 is assembled with the holder 100 and clamp 200 and secured with bolt 300 and torqued together as shown in FIG. 4B, the assembly is very strong and robust and the knife is securely held in the desired orientation by the mating surfaces described above to eliminate relative movement between the knife, holder and clamp during cutting operations. The mating surfaces of the clamp 200 and the flattened portions 28a and 28b, and 30a and 30b, and the mating surfaces of lower surface 34b and surface 102 of holder 100 significantly increases the clamping strength and security of the knife in the assembly. As bolt 300 is torqued to about 120 ft. lbs, the gap 250 described above closes (as shown in comparison between FIGS. 4A and 4B) and the three points of contact between knife, clamp and holder—that is, first point of contact 252, second point of contact 254, and third point of contact 256—are established. This compressive force between the clamp and the knife caused by the tightening of bolt 300 creates a spring-like effect that continuously biases or urges the clamp away from the knife while the bolt holds the assembly together. During chipping operations that biasing force increases the strength of the connection between the knife to the clamp and holder. The knife is prevented from twisting by the combined mating surfaces described. When the exposed knife edge dulls, the knife 10 may be removed very quickly and easily by loosening bolt 300. The knife may then be rotated by 180 degrees so that the opposite knife edge becomes the working edge. When both edges are dull the knife is just as easily removed and replace with a new or sharpened knife.

The preferred embodiment of a knife 10 has been described above. Two alternative configurations for a knife 10 according to the invention are shown in FIGS. 7 and 8. The knife shown in FIG. 7 is identified with reference number 400 and the knife of FIG. 8 is identified with reference number 500. Both knives 400 and 500 are substantially similar to the knife 10 of FIGS. 1 through 6 except the upper surface of the knives 400 and 500 are defined by a single sloping surface portion (402 and 404, FIGS. 7, and 502, 504, FIG. 8). The single sloping surface portions transition into second sloping surface portions 406, 408 (FIGS. 7) and 506, 508 (FIG. 8), which continue to the knife edges 410 (FIGS. 7) and 510 (FIG. 8). With specific reference to knife 400 of FIG. 7, the preferred angular slope of second sloping surface portions 402, 404 relative to a ground plane, is shown as angle X, which is preferably in the range of between 35 to 45 degrees. It will be understood that the knives 400 and 500 will be paired with clamps and holders that have complimentary mating surfaces to retain the knives in the assembled clamp/knife/holder combinations in the same manner described above with respect to the embodiment of FIG. 1.

In FIG. 8 a portion of clamp 600 is illustrated and arrow F shows the clamp force direction in the assembled clamp, knife, holder assembly. In the embodiment illustrated in FIG. 8, the upper surfaces 402 inwardly of the junction between surfaces 402 and 404 define a surge limiting surface that counteracts the extreme forces encountered during chipping operations. Thus, when the clamp 600 is in place as shown in FIG. 8, the surge limiting surface of the knife abuts the lower surface of the clamp. Likewise, with respect to the embodiment illustrated in FIG. 6, the upper surfaces 28a and 30a define the surge limiting surfaces to counteract the forces encountered during chipping. When the combination of the knife, clamp and holder is bolted together the clamp force direction F provides significant strength to the assembly to resist damage caused by working forces applied to the assembly during chipping operations. The dimension Cₛ in FIG. 8 signifies the effective cutting surface of knife 500 between edge 510 and the line 512 between the first and second sloped portions 502 and 502. The dimension Cₛ defines a relatively short cutting surface and this increases the strength of the knife.

The concave lower surfaces 34a and 34b of knife 10, when they abut facing convex surface 102 of holder 100 in the assembled knife, facilitate a smooth chipping means that results in improved chip quality. Furthermore, the length of dimension Cₛ is preferably as maintained as short as reasonably possible in order to better control a log or board during chipping operations.

It will be appreciated that the holder and clamp that is used with the knifes shown in FIGS. 7 and 8 having mating surfaces that are complementary to the surfaces of the knife in the same manner as described above.

It will be appreciated that certain structural modifications may be made to the components described above without compromising the functionality of the invention. As an example, the semi-circular ridges 18 and 24 may be of other geometric configurations (such as straight-sided ridges), in which case the groove 202 in clamp 200 would be of complementary shape. It will be appreciated therefore that the combination of the semicircular ridges 18 and 24 define locating structures that locate knife 10 in the desired position relative to holder 100 and clamp 200 both during assembly and operation; the locator as defined by the ridges 18 and 24 extend laterally and straddle the center line. It will further be appreciated that the ridges 18 and 24 may be replaced by equivalent structures that perform the same function, namely, positioning the knife in the desired orientation relative to the clamp and the holder. For instance, tabs and bosses may be used in place of the laterally extending ridges illustrated, and the ridges need not extend completely across the main body.

While the present invention has been described in terms of preferred and illustrated embodiments, it will be appreciated by those of ordinary skill that the spirit and scope of the invention is not limited to those embodiments, but extend to the various modifications and equivalents as defined in the appended claims.

1. A knife for wood chipping, comprising:
a rectangular main body having a center line, and upper and lower surfaces;
an upwardly extending locator on the upper surface;
wherein in side profile the main body defines a gull wing shape in which the upper surface slopes downwardly on opposite sides of the locator and the lower surface defines a concave surface on opposite sides of the center line and wherein the upper surface and lower surface meet on respective opposite sides of the main body to define first and second knife cutting edges.

2. The knife according to claim 1 in which the upwardly extending locator is defined by a semi-circular ridge that extends along the center line.

3. The knife according to claim 2 including a downwardly extending locator on the lower surface.

4. The knife according to claim 2 in which the downwardly extending locator is defined by a semi-circular ridge that extends along the center line.

5. The knife according to claim 1 in which the upper surface on each side of the upwardly extending locator is defined by a first planar section, a second planar section adjacent to and outwardly of the first planar section, and a third planar section adjacent to and outwardly of the second planar section.

6. The knife according to claim 5 in which, on each side of the upwardly extending locator, the second planar section slopes downwardly relative to the first planar section and the third planar section slopes downwardly relative to the second planar section.

7. The knife according to claim 1 wherein the upper surface is further defined by a first flattened portion on each opposite side of the upwardly extending locator, a first sloped portion on each opposite side of the locator immediately outward of the first flattened portions, and a second sloped portion on each opposite side of the first sloped portions and immediately outward of the first sloped portions.

8. The knife according to claim 7 wherein the upwardly extending locator extends along the center line.

9. The knife according to claim 8 in which the upwardly extending locator is semi-circular.

10. The knife according to claim 2 including a downwardly extending locator on the lower surface and along the center line.

11. The knife according to claim 10 wherein the downwardly extending locator is semi-circular.

12. The knife according to claim 1 in which the knife is bilaterally symmetrical about the center line.

13. The knife according to claim 12 in combination with a holder and a clamp, wherein each of the holder and the clamp defines surfaces that are complementary to at least a portion of the upper and lower surfaces of the knife.

14. A knife for wood chipping, comprising:
a bilaterally symmetrical and rectangular main body having a center line, and upper and lower surfaces, wherein the upper surface on each side of the center line defined by at least two adjacent planar surfaces that slope downwardly from the center line to a knife edge, and the lower surface on each side of the center line is defined by a concave surface that terminates at the center line;
a first locator means on the upper surface for locating the knife in a desired position relative to a holder and a clamp;
a second locator means on the lower surface for locating the knife in a desired position relative to the holder and clamp.

15. The knife according to claim 14 in which the first and second locator means are each defined by a semi-circular ridge extending from the respective upper and lower surfaces along the center line.

16. The knife according to claim 14 in which the upper surface on each side of the centerline is defined by a first surface, and adjacent second surface outwardly of the first surface and sloping downwardly relative to the first surface, and an adjacent third surface outwardly of the second surface and sloping downwardly relative to the second surface.

17. The knife according to claim 16 in the at least two first and second surfaces define surge limiting surfaces.

18. A knife for wood chipping, comprising:
a bilaterally symmetrical and rectangular main body having in side profile a gull wing shape, and including:
a center line, an upper locator extending away from the upper surface along the center line;
the upper surface on each side of the upper locator defined by:
a first surface immediately outward of the locator, a second surface outwardly of the first surface and sloping downwardly relative to the first surface, and
a third surface outwardly of the second surface and sloping downwardly relative to the second surface;
the lower surface on each side of the lower locator defined by a concave surface;
wherein, the third surfaces each have an outer edge and the concave surfaces each have an outer edge and the respective outer edges of the third surfaces meet the respective outer edges of the concave surfaces to define knife edges.

19. The knife according to claim 18 upper and lower locators are defined by semi-circular circular ridges that extend along the center line.

20. The knife according to claim 18 in which the semi-circular ridges extend completely across the main body.
